(19) United States
(12) Patent Application Publication
(10) Pub. No.: US 2025/0016562 A1
(43) Pub. Date: Jan. 9, 2025

(54) METHOD AND DEVICE FOR PERFORMING SECONDARY RE-AUTHENTICATION FOR A MA-PDU SESSION IN A WIRELESS COMMUNICATION SYSTEM

(71) Applicant: SAMSUNG ELECTRONICS CO., LTD., Suwon-si (KR)

(72) Inventors: Ashok Kumar NAYAK, Bangalore (IN); Lalith KUMAR, Bangalore (IN); Dongyeon KIM, Suwon-si (KR); Narendranath Durga TANGUDU, Bangalore (IN)

(21) Appl. No.: 18/765,155

(22) Filed: Jul. 5, 2024

(30) Foreign Application Priority Data
Jul. 6, 2023 (IN) 202341045545
Jun. 14, 2024 (IN) 202341045545

(51) Int. Cl. H04W 12/06; H04W 76/10; H04W 76/30

(52) U.S. Cl. CPC H04W 12/06; H04W 76/10; H04W 76/30

(57) ABSTRACT

Embodiments herein disclose a method and device for performing secondary re-authentication for a MA-PDU session in a wireless communication system. The method for performing authentication for a multi-access packet data unit (MA-PDU) session by a session management function+packet data network (PDN) gateway control plane function (SMF+PGW-C) in a wireless communication network is provided, the method comprises performing a procedure for secondary re-authentication of the MA-PDU session for a user equipment (UE) by selecting one of a first access type or a second access type in case that the SMF+PGW-C receives a re-authentication request from a data network-authentication, authorization, and accounting (DN-AAA) server, retrying a procedure for the secondary re-authentication of the MA-PDU session for the second access type in case that the SMF+PGW-C receives a failure indication for the secondary re-authentication that the UE is not reachable in the first access type, and retrying a procedure for the secondary re-authentication of the MA-PDU session for the first access type in case that the SMF+PGW-C receives a failure indication of the secondary re-authentication that the UE is not reachable in the second access type.

### CROSS REFERENCE TO RELATED APPLICATIONS

This application is based on and claims priority under 35 U.S.C. § 119 to Indian Provisional Application No. 202341045545, filed Jul. 6, 2023 in the Indian Intellectual Property Office, and Indian Complete application No. 202341045545, filed on Jun. 14, 2024 in the Indian Intellectual Property Office, the disclosures of which are incorporated by reference herein in their entirety.

### BACKGROUND

### 1. Field

Embodiments disclosed herein relate to wireless communication networks, and more particularly to supporting secondary authentication and authorization on the user equipment (UE) initiating the session establishment with the data network (DN).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure provides a method and device for performing secondary re-authentication for a MA-PDU session in a wireless communication system efficiently.

Accordingly, the embodiments herein provide a method for performing authentication for a multi-access packet data unit (MA-PDU) session by a session management function+packet data network (PDN) gateway control plane function (SMF+PGW-C) in a wireless communication network, the method comprises performing a procedure for secondary re-authentication of the MA-PDU session for a user equipment (UE) by selecting one of a first access type or a second access type in case that the SMF+PGW-C receives a re-authentication request from a data network-authentication, authorization, and accounting (DN-AAA) server, retrying a procedure for the secondary re-authentication of the MA-PDU session for the second access type in case that the SMF+PGW-C receives a failure indication for the secondary re-authentication that the UE is not reachable in the first access type, and retrying a procedure for the secondary re-authentication of the MA-PDU session for the first access type in case that the SMF+PGW-C receives a failure indication of the secondary re-authentication that the UE is not reachable in the second access type.

Accordingly, the embodiments herein provide a session management function+packet data network (PDN) gateway control plane function (SMF+PGW-C), the SMF+PGW-C comprises a communication interface, and a processor configured to perform, through the communicator, a procedure for secondary re-authentication of the MA-PDU session for a user equipment (UE) by selecting one of a first access type or a second access type in case that the SMF+PGW-C receives a re-authentication request from a data network-authentication, authorization, and accounting (DN-AAA) server, retry, through the communicator, a procedure for the secondary re-authentication of the MA-PDU session for the second access type in case that the SMF+PGW-C receives a failure indication for the secondary re-authentication that the UE is not reachable in the first access type, and retry, through the communicator, a procedure for the secondary re-authentication of the MA-PDU session for the first access type in case that the SMF+PGW-C receives a failure indication of the secondary re-authentication that the UE is not reachable in the second access type.

Accordingly, the embodiments herein provide a method for performing secondary re-authentication for a multi-access packet data unit (MA-PDU) session in a wireless communication network. The method comprises selecting, by a session management function+packet data network (PDN) gateway control plane function (SMF+PGW-C), an access type for performing secondary re-authentication for the MA-PDU session for a user equipment (UE), wherein the selected access type is one of a first access type and second access type. The method further comprises attempting, by the SMF+PGW-C, to perform secondary re-authentication of the MA-PDU session for the UE using one of the first access type or second access type. The method further comprises receiving by the SMF+PGW-C, a failure indication from one of the first access type or second access type that the UE is not reachable. The method further comprises re-attempting by the SMF+PGW-C, to perform secondary re-authentication of the MA-PDU session for the UE using the first access type if the second access type is not reachable, or using the second access type if the first access type is not reachable. The method further comprises informing, by the SMF+PGW-C, an error to a data network-authentication, authorization, and accounting (DN-AAA) server, if the UE is not reachable for re-authentication using both the first access type and the second access type.

Accordingly, the embodiments herein provide a session management function+packet data network (PDN) gateway control plane function (SMF+PGW-C). The SMF+PGW-C can select an access type for performing secondary re-authentication for a Multi-Access Packet Data Unit (MA-PDU) session for a user equipment (UE), wherein the selected access type is one of a first access type and second access type. The SMF+PGW-C can attempt to perform secondary re-authentication of the MA-PDU session for the UE using one of the first access type or second access type. The SMF+PGW-C can receive a failure indication from one of the first access type or second access type that the UE is not reachable. The SMF+PGW-C can re-attempt to perform secondary re-authentication of the MA-PDU session for the UE using the first access type if the second access type is not reachable, or using the second access type if the first access type is not reachable. The SMF+PGW-C can inform an error to a data network-authentication, authorization, and accounting (DN-AAA) server, if the UE is not reachable for re-authentication using both the first access type and the second access type.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIGS. 1A and 1B illustrate diagrams representing a sequence of events for secondary re-authentication triggered either by DN-AAA server or SMF for MA-PDU session;

FIG. 2 illustrates one or more nodes in a communication network, which support performing secondary authentication and authorization on the UE initiating the session establishment with the DN, according to embodiments of the present disclosure;

FIG. 3 illustrates a flowchart depicting a process for performing secondary re-authentication for the MA-PDU session in the wireless communication network, according to embodiments of the present disclosure;

FIG. 4 illustrates an example flowchart depicting a process for performing secondary re-authentication for the MA-PDU session in the wireless communication network, according to embodiments of the present disclosure;

FIG. 5 illustrates a diagram representing a sequence of events in which SMF/SMF+PGW-C tries both the access present in 5GC and EPC, according to embodiments of the present disclosure;

FIG. 6 illustrate a diagram representing an example of a sequence of events in which SMF/SMF+PGW-C tries 5GC and EPC as the first access type and the second access type, respectively, according to embodiments of the present disclosure;

FIG. 7 illustrates a diagram representing an example of a sequence of events in which SMF/SMF+PGW-C tries EPC and 5GC as the first access type and the second access type, respectively, according to embodiments of the present disclosure; and

FIG. 8 illustrates a flowchart depicting the method for performing secondary re-authentication for the multi-access packet data unit (MA-PDU) session in a wireless communication network, according to embodiments of the present disclosure.

### DETAILED DESCRIPTION

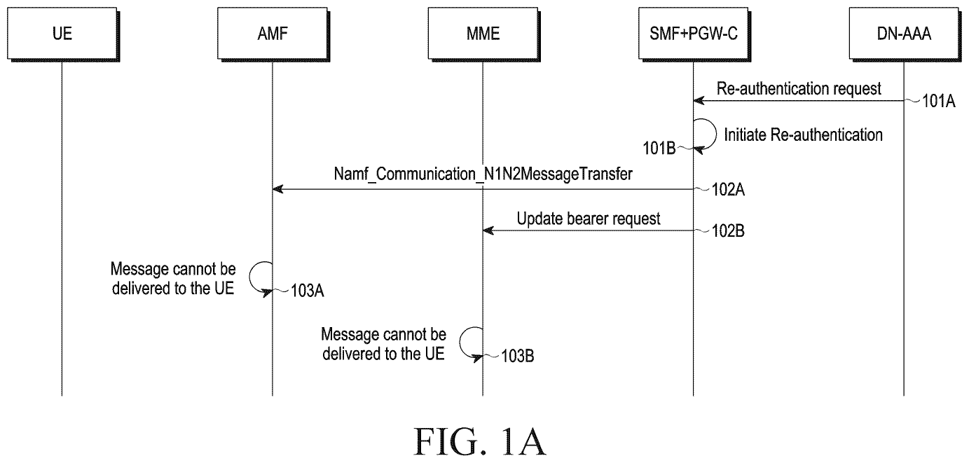

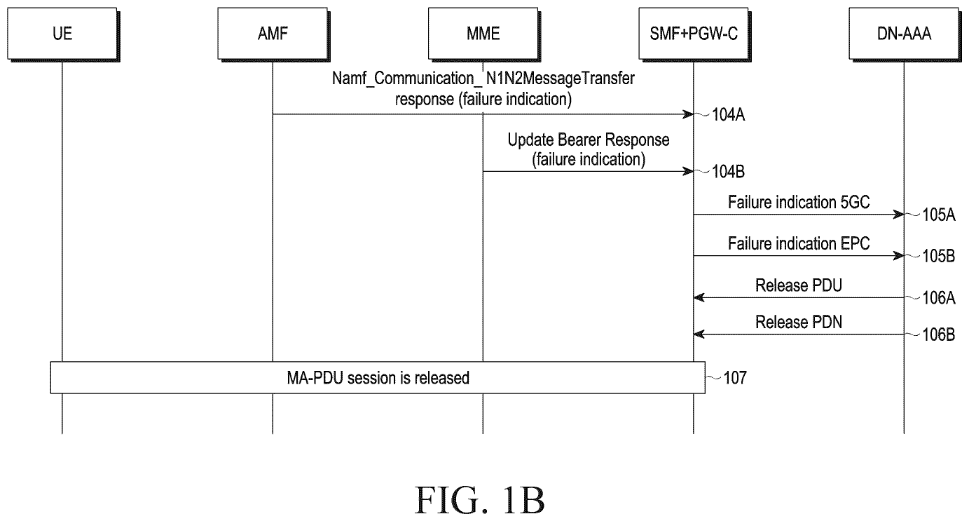

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The object of embodiments herein is to disclose systems and methods for managing the secondary re-authentication for an established multi-access protocol data unit (MA-PDU) session, on the UE initiating a session establishment with a data network (DN), or when a data network-authentication, authorization, and accounting (DN-AAA) server initiated, or a session management function (SMF) initiated secondary re-authentication for the MA-PDU session.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having,” and “including” are to be construed as open-ended terms unless otherwise noted.

The words/phrases “exemplary,” “example,” “illustration,” “in an instance,” “and the like,” “and so on,” “etc.,” “etcetera,” “e.g.,” “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” “i.e.,” is not necessarily to be construed as preferred or advantageous over other embodiments.

As used herein, each of such phrases as “A or B”, “at least one of A and B”, “at least one of A or B”, “A, B, or C”, “at least one of A, B, and C” and “at least one of A, B, or C,” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

For ease of description, the terms and names defined in the latest 3rd generation partnership project 5G and NR standards among the current communication standards are used herein. However, the disclosure is not limited by such terms and names and may be likewise applicable to wireless communication networks conforming to other standards. In particular, the disclosure may be applied to 3GPP GS/NR (5th generation mobile communication standards).

In embodiments of the present disclosure, each network entity may be implemented including a processor for controlling operations in accordance with each embodiment or combination of at least one embodiment, and a network interface/transceiver for communicating with other network entity on a wired/wireless network.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

In the older generation systems, DNs conduct the access control by themselves without the support of mobile operator after the user plane tunnel has been established between the UE and the DN. This may allow malicious UEs to invoke authentication service(s), provided by the DN resulting in a denial of service (DOS) attack. The 5G system allows mobile operators to delegate the authentication and authorization to a third party hosting the DN. This is achieved by introducing the concept of secondary authentication, which is executed during the establishment of user plane connection after the successful primary authentication. TS 23.501, Clause 5.6.6 describes the architecture details and TS 23.502, Clause 5.3.2.3 describes the procedural details about the secondary authentication and authorization with a data network-authentication, authorization, and accounting (DN-AAA) server when the UE is in 5G core (5GC).

3GPP Rel 18 supported the secondary authentication and authorization during packet data network (PDN) connection establishment when the UE is in evolved packet core (EPC) as well for Third Generation Partnership Project (3GPP) access. TS 23.502, Annex H describes the procedural details.

The secondary authentication and authorization occur during protocol data unit (PDU) session establishment based on the session management function (SMF) policy associated with the DN, or based on the configuration in the subscription profile of the UE for the associated DN. In this process, the SMF takes the role of an extensible authentication protocol (EAP) authenticator, but the actual authentication and authorization messages are exchanged between the UE, and the DN-AAA server (i.e., the EAP server).

Similarly, when the UE triggers a PDN connection and supports the secondary authentication and authorization in EPC, then based on a session management function+packet data network (PDN) gateway control plane function (SMF+PGW-C) policy associated with the DN or based on the configuration in the subscription profile of the UE for the associated DN, secondary authentication and authorization takes place.

A multi-access PDU Connectivity Service can exchange PDUs between the UE and a data network by simultaneously using one 3GPP access network, and one non-3GPP access network connected by two independent N3/N9 tunnels between the PDU session anchor (PSA) and radio access network (RAN)/access network (AN). The multi-access PDU Connectivity Service is realized by establishing a Multi-Access PDU (MA-PDU) Session, i.e., a PDU Session that may have user-plane resources on two access networks.

Consider that a UE (that supports secondary authentication and authorization in EPC) triggers MA-PDU. When establishing the MA-PDU session, consider that secondary authentication and authorization have been done successfully. Now at any point in time, either the DN-AAA server or the SMF/SMF+PGW-C may initiate the secondary re-authentication. The SMF/SMF+PGW-C may choose one of the accesses (either in 5GC or EPC), based on the operator policy to trigger secondary re-authentication and re-authorization. If re-authentication and reauthorization result is successful, then the existing session will be continued. But if the SMF/SMF+PGW-C receives an indication from the application management function (AMF) or the mobility management entity (MME) that the UE is unreachable, then the SMF/SMF+PGW-C informs the DN-AAA server that the UE is not reachable for re-authentication. Based on this indication from the SMF+PGW-C, the DN-AAA server may decide to keep the PDU session/PDN connection or request to release the PDU session/PDN connection. The consequence is that if the DN-AAA server decides to release the PDU session, the entire MA-PDU session will be released.

Consider FIGS. 1A and 1B, which illustrate diagrams representing a sequence of events for secondary re-authentication triggered either by DN-AAA server or SMF/SMF+PGW-C for MA-PDU session. Consider that the UE has been successfully authenticated and authorized by the DN-AAA server and a MA-PDU session is already established. In steps 101A, and 101B, the DN-AAA server or the SMF initiates re-authentication. In steps 102A, and 102B, the SMF/SMF+PGW-C chooses one of the accesses (either from 5GC or EPC) and sends the message to the AMF or the MME respectively. Consider that the UE has already indicated its support for secondary authentication and authorization over the EPC. In steps 103A, and 103B, the AMF identifies that the messages cannot be delivered to the UE (which can be due to reasons, such as, but not limited to, UE being in CM-IDLE state and only registered on n3gpp access, and so on). The MME subsequently identifies that the messages cannot be delivered to the UE. In steps 104A, and 104B, the AMF updates the SMF/SMF+PGW-C with an indication that the message cannot be delivered to the UE, if the AMF had received the request from SMF/SMF+PGW-C in step 103A. The MME updates the SMF/SMF+PGW-C with an indication that the message cannot be delivered to the UE, if the MME had received the request from the SMF/SMF+PGW-C in step 103B. In steps 105A, and 105B, the SMF/SMF+PGW-C informs the DN-AAA server that the UE is not reachable for re-authentication and optionally, provides the 5GC radio access technology (RAT) (if the SMF/SMF+PGW-C had received the failure indication from the AMF in step 104A). The SMF/SMF+PGW-C informs the DN-AAA server that the DN-AAA server that the UE is not reachable for re-authentication and optionally provided EPC RAT (if the SMF/SMF+PGW-C had received the failure indication from the MME in step 104B). In steps 106A and 106B, the DN-AAA server may send the message to release the PDU and PDN. In step 107, the whole MA-PDU session is released. For simplicity and clarity, nodes present between the MME & the SMF/SMF+PGW-C, such as, but not limited to, the RAN, serving gateway (SGW), and so on, are not depicted in FIGS. 1A, and 1B.

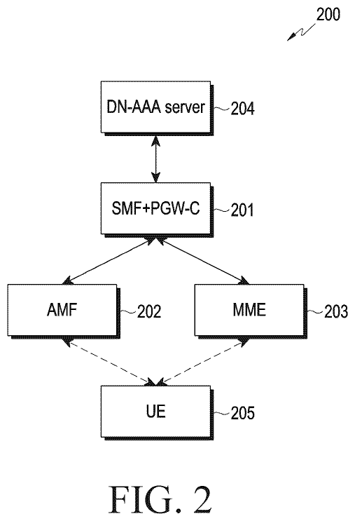

The embodiments herein achieve systems and methods for managing the secondary re-authentication for an established multi-access protocol data unit (MA-PDU) session, on the UE initiating a session establishment with a data network (DN). Referring now to the drawings, and more particularly to FIGS. 2 through 8, where similar reference characters denote corresponding features consistently throughout the figures, there are shown embodiments.

FIG. 2 illustrates one or more nodes in a communication network, which support performing secondary authentication and authorization on the UE initiating the session establishment with the DN. The network 200 comprises a session management function+packet data network (PDN) gateway control plane function (SMF+PGW-C) node 201 (hereinafter referred to as SMF+PGW-C), an application management function (AMF) 202, a mobility management entity (MME) 203, a data network-authentication, authorization, and accounting (DN-AAA) server 204, and at least one user equipment (UE) 205. The SMF+PGW-C that is a combination node of a session management function (SMF) in a 5G system (5GS) and a packet data network gateway-control (PGW-C) in an evolved packet system (EPS).

Embodiments herein address the problem of performing secondary re-authentication for an MA-PDU session which could not get executed because the UE 205 was not reachable, and the DN-AAA server 204 has been informed of the same by the SMF+PGW-C 201. On the SMF+PGW-C 201 receiving the indication from the AMF 202 or the MME 203 that the UE 205 is not reachable, then the SMF+PGW-C 201 does not inform the error to the DN-AAA server 204, and the SMF+PGW-C 201 can execute the secondary re-authentication on the other access. If the SMF+PGW-C 201 had received the indication of unreachability from the AMF 202, then the SMF+PGW-C 201 can execute the secondary re-authentication on the EPC (using the MME 203). If the SMF+PGW-C 201 had received the indication of unreachability from the MME 203, then the SMF+PGW-C 201 can execute the secondary re-authentication on 5GC (using the AMF 202).

Only when the SMF+PGW-C 201 has tried on both 5GC and EPC and an indication is received from both the AMF 202 and the MME 203 that the UE 205 is not reachable, then the SMF+PGW-C 201 can inform the DN-AAA server 204 that secondary re-authentication could not get executed, as the UE 205 was not reachable. In an embodiment herein, when informing the DN-AAA server 204 that secondary re-authentication could not get executed (i.e., authentication failure (i.e., error)), as the UE 205 was not reachable, the SMF+PGW-C 201 can provide the radio access technology (RAT) types as the 5GC and the EPC to indicate SMF+PGW-C 201 has tried on both accesses from the 5GC and the EPC. If re-authentication is triggered successfully, the SMF+PGW-C 201 can send a message to the UE 205. If the re-authentication fails, the SMF+PGW-C 201 can release the session from both accesses of 5GC and EPC.

In an embodiment herein, if the SMF+PGW-C 201 determines that both access of MA-PDU session is present in 5GC and no specific access type (3GPP or non-3GPP) is mentioned by the SMF+PGW-C 201 (while sending the re-authentication message to the AMF 202), then the AMF 202 can try on both accesses to send the message to the UE 205, and if AMF 202 fails on both accesses, then only the AMF 202 can provide the failure indication to the SMF+PGW-C 201.

In an embodiment herein, if the SMF+PGW-C 201 determines that both accesses of the MA-PDU session are present in 5GC and one access type is mentioned by the SMF+PGW-C 201 (while sending the re-authentication message to the AMF 202) and then if the SMF+PGW-C 201 receives a failure indication from the AMF 202 that the message cannot be delivered, then the SMF+PGW-C 201 can mention the other access type, when sending the re-authentication message to the AMF 202. Only when both accesses have been tried and a failure indication is received from both accesses, the SMF+PGW-C 201 can inform the DN-AAA server 204 that the re-authentication cannot be executed. In an embodiment herein, the SMF+PGW-C 201 can also provide both 3GPP and non-3GPP AT to the DN-AAA server 204.

For simplicity and clarity, nodes present in the wireless communication network, between the MME & the SMF+PGW-C, such as, but not limited to, the RAN, and so on, are not depicted in FIG. 2.

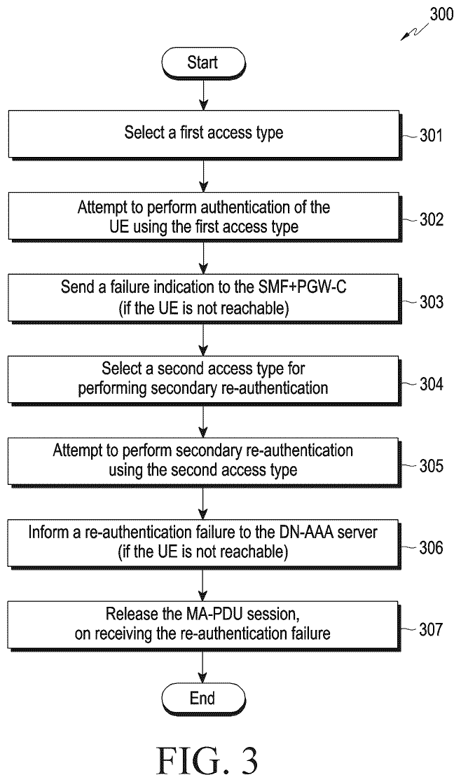

FIG. 3 illustrates a flowchart depicting a process for performing secondary re-authentication for the MA-PDU session in the wireless communication network. In step 301, the SMF+PGW-C 201 selects a first access type (which can be at least one of, but not limited to, 5GC, EPC, non-3GPP AT, and so on). In step 302, the SMF+PGW-C 201 attempts to perform authentication of the UE 205 using the first selected access type (which can be via a first entity corresponding to the selected first access type, i.e., if the first access type is 5GC, the first entity is the AMF 202, and if the first access type is EPC, the first entity is the MME 203). This can involve the first entity attempting to send a message to the UE 205. If the UE 205 is reachable, the first entity authorizes the UE 205. If the UE 205 is not reachable, in step 303, the first entity sends a failure indication to the SMF+PGW-C 201. In step 304, the SMF+PGW-C 201 selects a second access type for performing secondary re-authentication for the MA-PDU session for the UE. In step 305, the SMF+PGW-C 201 attempts to perform secondary re-authentication of the MA-PDU session for the UE 205 using the selected second access type (which can be via a second entity corresponding to the selected second access type, i.e., if the second access type is EPC, the second entity is the MME 203, and if the second access type is 5GC, the second entity is the AMF 202). If the UE 205 is not reachable using the selected second access type, in step 306, the SMF+PGW-C 201 informs an error to the DN-AAA server 204. Along with the error, in an embodiment herein, the SMF+PGW-C 201 can also inform the first access type, and the selected second access type to the DN-AAA server 204. In step 307, the DN-AAA server 204 releases the MA-PDU session, on receiving the error from the SMF+PGW-C 201. The various actions in method 300 may be performed in the order presented, in a different order or simultaneously. Further, in some embodiments, some actions listed in FIG. 3 may be omitted.

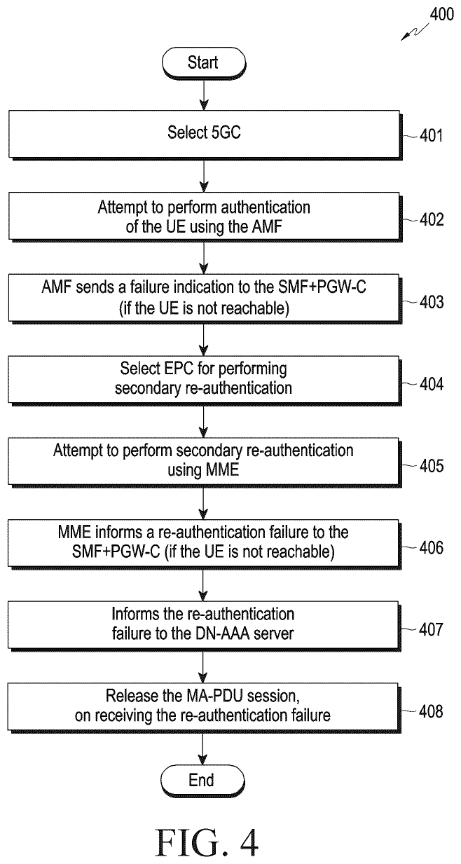

FIG. 4 illustrates an example flowchart depicting a process for performing secondary re-authentication for the MA-PDU session in the wireless communication network. In step 401, the SMF+PGW-C 201 selects 5GC as the first access type. In step 402, the SMF+PGW-C 201 attempts to perform authentication of the UE 205 using the AMF 202. This can involve the AMF 202 attempting to send a message to the UE 205. If the UE 205 is reachable, the AMF 202 authorizes the UE 205. If the UE 205 is not reachable, in step 403, the AMF 202 sends a failure indication to the SMF+PGW-C 201. In step 404, the SMF+PGW-C 201 selects EPC as the second access type for performing secondary re-authentication for the MA-PDU session for the UE. In step 405, the SMF+PGW-C 201 attempts to perform secondary re-authentication of the MA-PDU session for the UE 205 using the MME 203. If the UE 205 is not reachable via the MME 203, in step 406, the MME 203 informs the re-authentication failure to the SMF+PGW-C 201. In step 407, the SMF+PGW-C 201 informs the re-authentication failure (i.e., error) to the DN-AAA server 204. Along with the error, in an embodiment herein, the SMF+PGW-C 201 can also inform the 5GC as the first access type), and EPC as the selected second access type to the DN-AAA server 204. In step 408, the DN-AAA server 204 releases the MA-PDU session, on receiving the error from the SMF+PGW-C 201. The various actions in method 400 may be performed in the order presented, in a different order or simultaneously. Further, in some embodiments, some actions listed in FIG. 4 may be omitted.

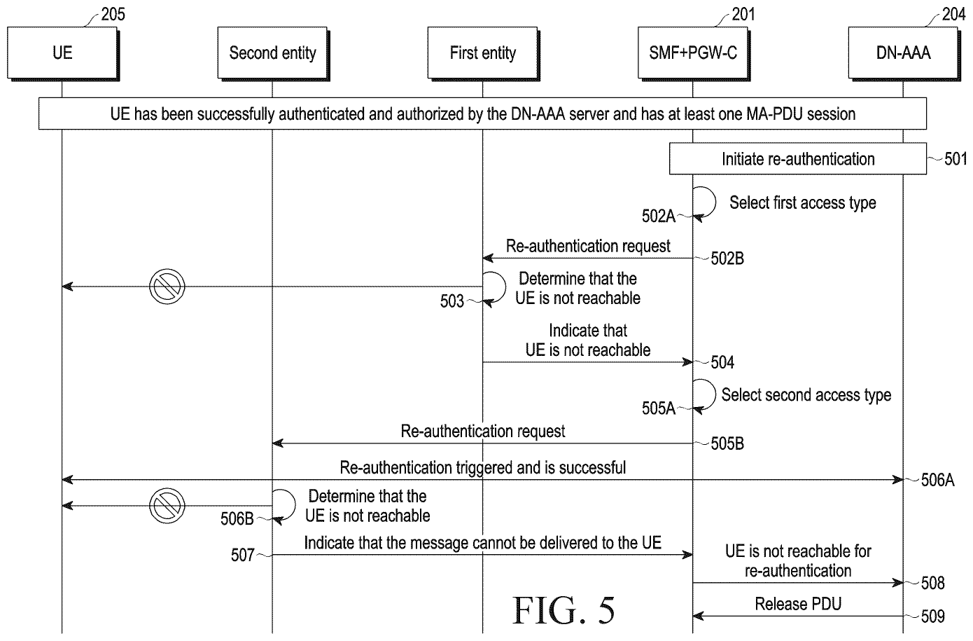

FIG. 5 illustrates a diagram representing a sequence of events in which SMF/SMF+PGW-C tries both the access present in 5GC and EPC. Consider that the UE has been successfully authenticated and authorized by the DN-AAA server and at least one MA-PDU session has already been established. In step 501, an entity, which can be one of the DN-AAA server 204, or the SMF+PGW-C 201 initiates re-authentication (based on SMF policy). In steps 502A and 502B, the SMF/SMF+PGW-C 201 selects a first access type (for example, the first access type can be one of 5GC or EPC) and sends the message to a corresponding first entity (which can be one of the AMF 202 or the MME 203 respectively, and can be based on the selected first access type), and sends a re-authentication request to the corresponding first entity. In step 503, the first entity determines that the messages cannot be delivered to the UE 205. In step 504, the first entity updates the SMF/SMF+PGW-C 201 with an indication that the message cannot be delivered to the UE 205. In steps 505A and 505B, the SMF/SMF+PGW-C 201 chooses a second access type (for example, the second access type can be one of 5GC or EPC) and sends a message to the second entity (which can be one of the AMF 202 or the MME 203 respectively, and can be based on the selected second access type) and sends a re-authentication request to the corresponding second entity, wherein the second entity attempts to send the message to the UE 205. In step 506A, the message is successfully sent to the UE and re-authentication flow is executed by reusing the call flow as per TS 23.502, Annex H.2.1, and the MA-PDU session is retained. In step 506B, the second entity determines that the messages cannot be delivered to the UE 205, as the UE is not reachable. In step 507, the second entity updates the SMF/SMF+PGW-C 201 with an indication that the message cannot be delivered to the UE 205. In step 508, the SMF/SMF+PGW-C 201 informs the DN-AAA server 204 that the UE 205 is not reachable for re-authentication (i.e., re-authentication is a failure (error)). In an embodiment herein, the SMF/SMF+PGW-C 201 can also provide the first access type, and the second access type as the SMF+PGW-C 201 has attempted authentication over both access types. In step 509, the DN-AAA server 204 may send the message to release the PDU. For simplicity and clarity, nodes present between the MME & the SMF+PGW-C, such as, but not limited to, the RAN, SGW, and so on, are not depicted in FIG. 5.

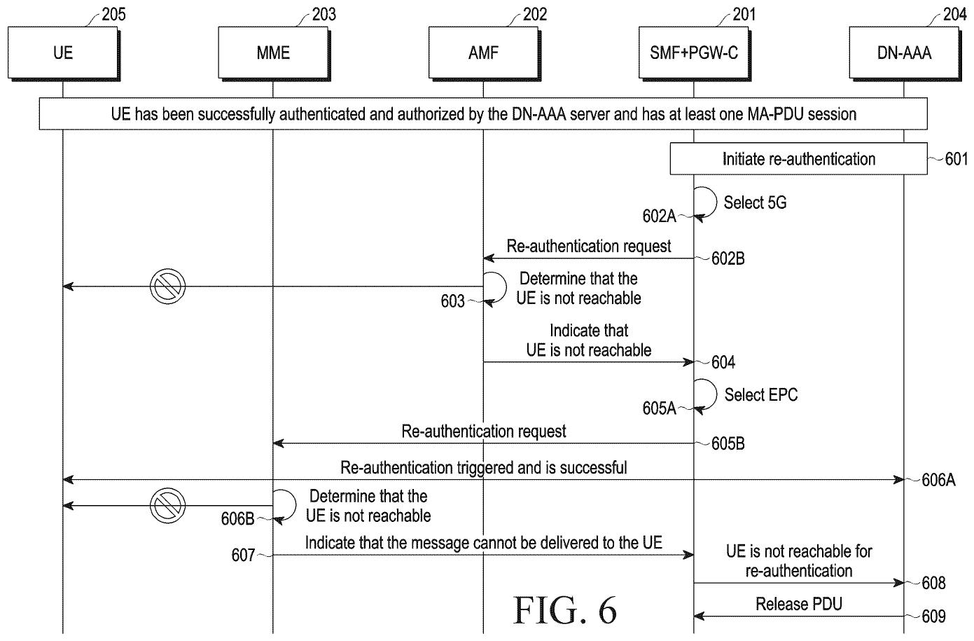

FIG. 6 illustrates a diagram representing an example of a sequence of events in which SMF/SMF+PGW-C tries 5GC and EPC as the first access type and the second access type, respectively. Consider that the UE has been successfully authenticated and authorized by the DN-AAA server and at least one MA-PDU session has already been established. In step 601, an entity, which can be one of the DN-AAA server 204, or the SMF+PGW-C 201 initiates re-authentication (based on the SMF policy). In steps 602A and 602B, the SMF/SMF+PGW-C 201 chooses 5GC (i.e., the first access type) for performing authentication and sends the message (i.e., Namf_Communication_NIN2MessageTransfer) to the AMF 202. In step 603, the AMF 202 attempts to deliver a message to the UE 205 and determines that the messages cannot be delivered to the UE 205 (in scenarios, such as, but not limited to, UE 205 being in CM-IDLE state, UE 205 being registered on n3gpp access, and so on). In step 604, the AMF 202 updates the SMF/SMF+PGW-C 201 with an indication (i.e., Namf_Communication_NIN2MessageTransfer response (failure indication)) that the message cannot be delivered to the UE 205. In step 605, the SMF/SMF+PGW-C 201 chooses EPC (i.e., the second access type), and sends the message (i.e., update bearer request) to the MME 203. In step 606A, the message is successfully sent to the UE 205 by the MME 203 and re-authentication flow is executed by reusing the call flow as per TS 23.502, Annex H.2.1, and the MA-PDU session is retained. In step 606B, the MME 203 determines that the messages cannot be delivered to the UE 205 (in scenarios, such as, but not limited to, UE 205 being in CM-IDLE state, UE 205 being registered on n3gpp access, and so on). In step 607, the MME 203 updates the SMF/SMF+PGW-C 201 with an indication (i.e., update bearer response (failure indication)) that the message cannot be delivered to the UE 205. In step 608, the SMF/SMF+PGW-C 201 informs the DN-AAA server 204 that the UE 205 is not reachable for re-authentication (i.e., re-authentication is a failure (i.e., error)). In an embodiment herein, the SMF/SMF+PGW-C 201 can also provide the 5GC RAT and EPC RAT as the SMF+PGW-C 201 has tried over both accesses from 5GC and EPC. In step 609, the DN-AAA server 204 may send the message to release the PDU. For simplicity and clarity, nodes present between the MME & the SMF+PGW-C, such as, but not limited to, the RAN, SGW, and so on, are not depicted in FIG. 6.

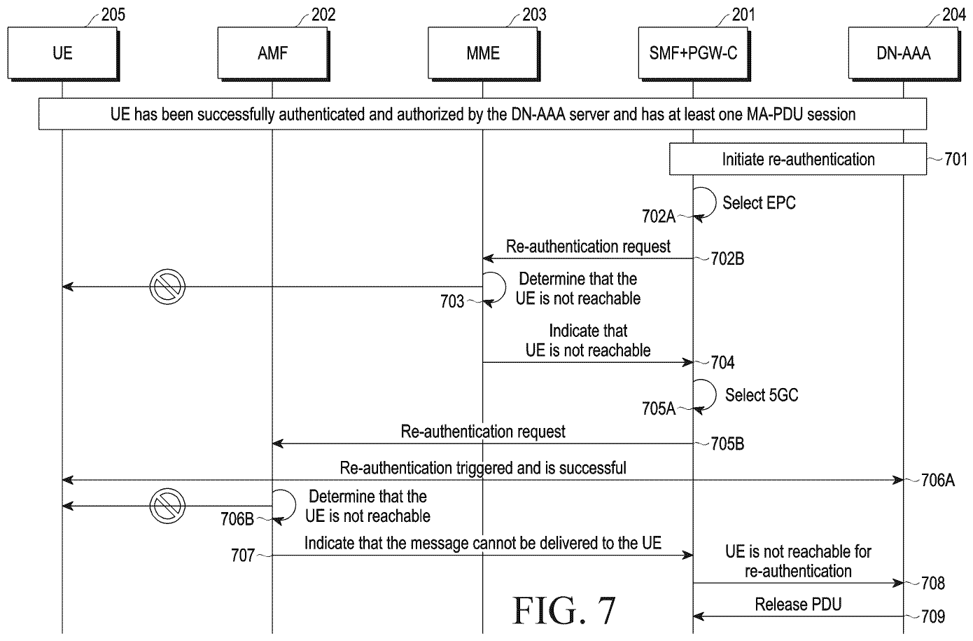

FIG. 7 illustrates a diagram representing an example of a sequence of events in which SMF/SMF+PGW-C tries EPC and 5GC as the first access type and the second access type, respectively. Consider that the UE has been successfully authenticated and authorized by the DN-AAA server and at least one MA-PDU session has already been established. In step 701, an entity, which can be one of the DN-AAA server 204, or the SMF+PGW-C 201 initiates re-authentication (based on the SMF policy). In steps 702A and 702B, the SMF/SMF+PGW-C 201 chooses the EPC (i.e., the first access type) and sends the message (update bearer request) to the MME 203. In step 703, the MME 203 attempts to deliver a message to the UE 205 and determines that the messages cannot be delivered to the UE 205 (in scenarios, such as, but not limited to, UE 205 being in CM-IDLE state, UE 205 being registered on n3gpp access, and so on). In step 704, the MME 203 updates the SMF/SMF+PGW-C 201 with an indication (i.e., update bearer response (failure indication)) that the message cannot be delivered to the UE 205. In step 705, the SMF/SMF+PGW-C 201 chooses 5GC (i.e., the second access type), and sends a message (i.e., Namf_Communication_NIN2MessageTransfer) to the AMF 202. In step 706A, the message is successfully sent to the UE and re-authentication flow is executed by reusing the call flow as per TS 23.502 Annex, H.2.1, and the MA-PDU session is retained. In step 706B, the AMF 202 determines that the messages cannot be delivered to the UE 205 (in scenarios, such as, but not limited to, UE 205 being in CM-IDLE state, UE 205 being registered on n3gpp access, and so on). In step 707, the AMF 202 updates the SMF/SMF+PGW-C 201 with an indication (i.e., Namf_Communication_NIN2MessageTransfer response (failure indication)) that the message cannot be delivered to the UE 205. In step 708, the SMF/SMF+PGW-C 201 informs the DN-AAA server 204 that the UE 205 is not reachable for re-authentication (i.e., re-authentication is a failure). In an embodiment herein, the SMF/SMF+PGW-C 201 can also provide the EPC RAT and 5GC RAT as the SMF+PGW-C 201 has tried over both accesses from EPC and 5GC. In step 709, the DN-AAA server 204 may send the message to release the PDU. For simplicity and clarity, nodes present between the MME & the SMF+PGW-C, such as, but not limited to, the RAN, SGW, and so on, are not depicted in FIG. 7.

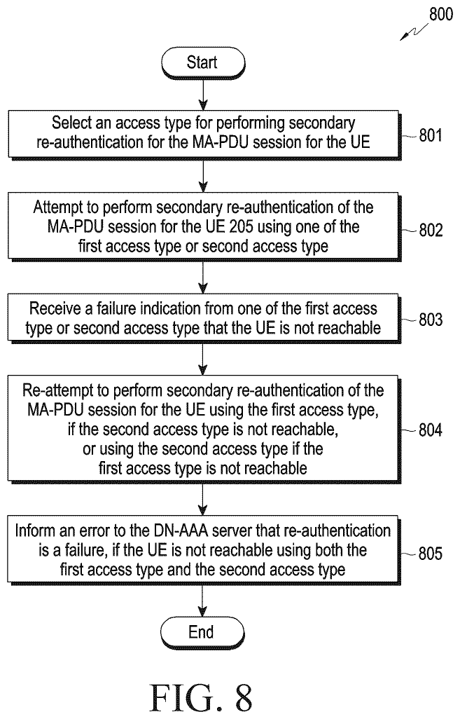

FIG. 8 illustrates a flowchart depicting the method for performing secondary re-authentication for the multi-access packet data unit (MA-PDU) session in a wireless communication network. In step 801, the SMF+PGW-C 201 selects an access type for performing secondary re-authentication for the MA-PDU session for the UE 205. The selected access type can be one of the first access type and the second access type. The first access type can be one of a 3GPP connected to EPC, and a non-3GPP connected to 5GC. The second access type can be one of a non-3GPP connected to 5GC, and a 3GPP connected to EPC. In step 802, the SMF+PGW-C 201 attempts to perform secondary re-authentication of the MA-PDU session for the UE 205 using one of the first access type or second access type. In step 803, the SMF+PGW-C 201 receives a failure indication from one of the first access type or second access type that the UE 205 is not reachable. In step 804, the SMF+PGW-C 201 re-attempts to perform secondary re-authentication of the MA-PDU session for the UE 205 using the first access type, if the second access type is not reachable, or using the second access type if the first access type is not reachable. In step 805, the SMF+PGW-C 201 informs an error to the DN-AAA server 204 that re-authentication is a failure if the UE is not reachable using both the first access type and the second access type. The various actions in method 800 may be performed in the order presented, in a different order or simultaneously. Further, in some embodiments, some actions listed in FIG. 8 may be omitted.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe systems and methods for managing the secondary re-authentication for an established multi-access protocol data unit (MA-PDU) session, on the UE initiating a session establishment with a data network (DN). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the present disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for performing authentication for a multi-access packet data unit (MA-PDU) session by a session management function+packet data network (PDN) gateway control plane function (SMF+PGW-C) in a wireless communication network, the method comprising:
performing a procedure for secondary re-authentication of the MA-PDU session for a user equipment (UE) by selecting one of a first access type or a second access type in case that the SMF+PGW-C receives a re-authentication request from a data network-authentication, authorization, and accounting (DN-AAA) server;
retrying a procedure for the secondary re-authentication of the MA-PDU session for the second access type in case that the SMF+PGW-C receives a failure indication for the secondary re-authentication that the UE is not reachable in the first access type; and
retrying a procedure for the secondary re-authentication of the MA-PDU session for the first access type in case that the SMF+PGW-C receives a failure indication of the secondary re-authentication that the UE is not reachable in the second access type.

2. The method of claim 1, wherein the first access type is one of an evolved packet core (EPC) and a fifth generation core (5GC), and the second access type is another one of the EPC and the 5GC.

3. The method of claim 1, wherein the first access type is one of a third generation partnership project (3GPP) access and a non-3GPP access, and the second access type is another one of the 3GPP access and the non-3GPP access.

4. The method of claim 1, wherein in case that the one access type selected by the SMF+PGW-C is non-3GPP connected to 5GC, the failure indication is received from an access mobility function (AMF).

5. The method of claim 1, wherein in case that the one access type selected by SMF+PGW-C is 3GPP connected to EPC, the failure indication is received from a mobility management entity (MME).

6. The method of claim 1, further comprising informing the DN-AAA server that the UE is not reachable for the secondary re-authentication in case that the SMF+PGW-C receives the failure indication that the UE is not reachable in both the first access type and the second access type, respectively.

7. The method of claim 6, further comprising releasing the MA-PDU session in case that the SMF+PGW-C receives the failure indication that the UE is not reachable in both the first access type and the second access type, respectively.

8. A session management function+packet data network (PDN) gateway control plane function (SMF+PGW-C), the SMF+PGW-C comprising:
a communication interface; and
a processor configured to:
perform, through a communicator, a procedure for secondary re-authentication of a MA-PDU session for a user equipment (UE) by selecting one of a first access type or a second access type in case that the SMF+PGW-C receives a re-authentication request from a data network-authentication, authorization, and accounting (DN-AAA) server,
retry, through the communicator, a procedure for the secondary re-authentication of the MA-PDU session for the second access type in case that the SMF+PGW-C receives a failure indication for the secondary re-authentication that the UE is not reachable in the first access type, and
retry, through the communicator, a procedure for the secondary re-authentication of the MA-PDU session for the first access type in case that the SMF+PGW-C receives a failure indication of the secondary re-authentication that the UE is not reachable in the second access type.

9. The SMF+PGW-C of claim 8, wherein the first access type is one of an evolved packet core (EPC) and a fifth generation core (5GC), and the second access type is another one of the EPC and the 5GC.

10. The SMF+PGW-C of claim 8, wherein the first access type is one of a third generation partnership project (3GPP) access and a non-3GPP access, and the second access type is another one of the 3GPP access and the non-3GPP access.

11. The SMF+PGW-C of claim 8, wherein in case that the one access type selected by the SMF+PGW-C is non-3GPP connected to 5GC, the failure indication is received from an access mobility function (AMF).

12. The SMF+PGW-C of claim 8, wherein in case that the one access type selected by SMF+PGW-C is 3GPP connected to EPC, the failure indication is received from a mobility management entity (MME).

13. The SMF+PGW-C of claim 8, wherein the processor is further configured to inform, through the communicator, the DN-AAA server that the UE is not reachable for the re-authentication in case that the SMF+PGW-C receives the failure indication that the UE is not reachable in both the first access type and the second access type, respectively.

14. The SMF+PGW-C of claim 13, wherein the processor is further configured to release the MA-PDU session in case that the SMF+PGW-C receives the failure indication that the UE is not reachable in both the first access type and the second access type, respectively.
